(19) United States
(12) Patent Application Publication
(10) Pub. No.: US 2026/0195235 A1
(43) Pub. Date: Jul. 9, 2026

(54) OS AGNOSTIC ATTESTATION OF AN IHS SYSTEM AND METHOD

(71) Applicant: Dell Products L.P., Round Rock, TX (US)

(72) Inventors: Eugene David Cho, Austin, TX (US); Mukund P. Khatri, Austin, TX (US); Chandrashekar Nelogal, Round Rock, TX (US)

(73) Assignee: Dell Products L.P., Round Rock, TX (US)

(21) Appl. No.: 19/011,992

(22) Filed: Jan. 7, 2025

(51) Int. Cl. G06F 11/3604

(52) U.S. Cl. CPC G06F 11/3608

(57) ABSTRACT

Systems and methods for an OS agnostic attestation of an IHS system and method are described. According to one embodiment, a Baseboard Management Controller (BMC) includes program instructions that, upon execution by the processor, cause the BMC to perform one or more attestation measurements on software configured in the IHS, communicate with a Trusted Platform Module (TPM) proxy to obtain golden measurements associated with the software, and determine whether any of the attestation measurements are unexpected. Based upon the determination, the BMC may perform one or more remediation policies.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of "Infrastructure as a Service" (IaaS), "Platform as a Service" (PaaS), and/or "Software as a Service" (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

Systems and methods for an OS agnostic attestation of an IHS system and method are described. According to one embodiment, a Baseboard Management Controller (BMC) includes program instructions that, upon execution by the processor, cause the BMC to perform one or more attestation measurements on software configured in the IHS, communicate with a Trusted Platform Module (TPM) proxy to obtain golden measurements associated with the software, and determine whether any of the attestation measurements are unexpected. Based upon the determination, the BMC may perform one or more remediation policies.

According to another embodiment, an Operating System (OS) agnostic attestation method includes the steps of performing, using a Baseboard Management Controller (BMC), one or more current attestation measurements on software configured in an Information Handling System (IHS) using a Trusted Platform Module (TPM) proxy, obtaining, using the BMC, golden measurements associated with the software, determining, using the BMC, whether any of the attestation measurements are unexpected, and performing, using the BMC, one or more remediation policies based on the determination.

According to yet another embodiment, a non-transitory memory storage device with program instructions stored thereon that, upon execution by a Baseboard Management Controller (BMC), cause the BMC to perform one or more current attestation measurements on software configured in an Information Handling System (IHS) using a Trusted Platform Module (TPM) proxy, obtain golden measurements associated with the software, determine whether any of the attestation measurements are unexpected; and perform one or more remediation policies based on the determination.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 shows an example of an IHS that may be configured to implement an Operating System (OS) agnostic attestation of an IHS system and method according to one embodiment of the present disclosure.

FIG. 2A illustrates an example OS agnostic attestation of an IHS system showing how firmware, configuration, and software, as well as hardware, may be attested without the necessity of an OS host agent according to one embodiment of the present disclosure.

FIG. 2B illustrates an example timeline illustrating how the example OS agnostic attestation of an IHS system may perform attestation on the components of the IHS according to one embodiment of the present disclosure.

FIG. 3 illustrates an example vendor factory golden baseline generation method that may be performed by a vendor of the IHS according to one embodiment of the present disclosure.

FIG. 4 illustrates an example customer golden baseline generation method that may be performed by a customer of the IHS according to one embodiment of the present disclosure.

FIG. 5 illustrates an example boot-time attestation method that may be performed to attest the firmware and hardware during a boot process of an IHS according to one embodiment of the present disclosure.

FIG. 6 illustrates an example OS agnostic remote attestation method that may be performed to attest the firmware and hardware of an IHS according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

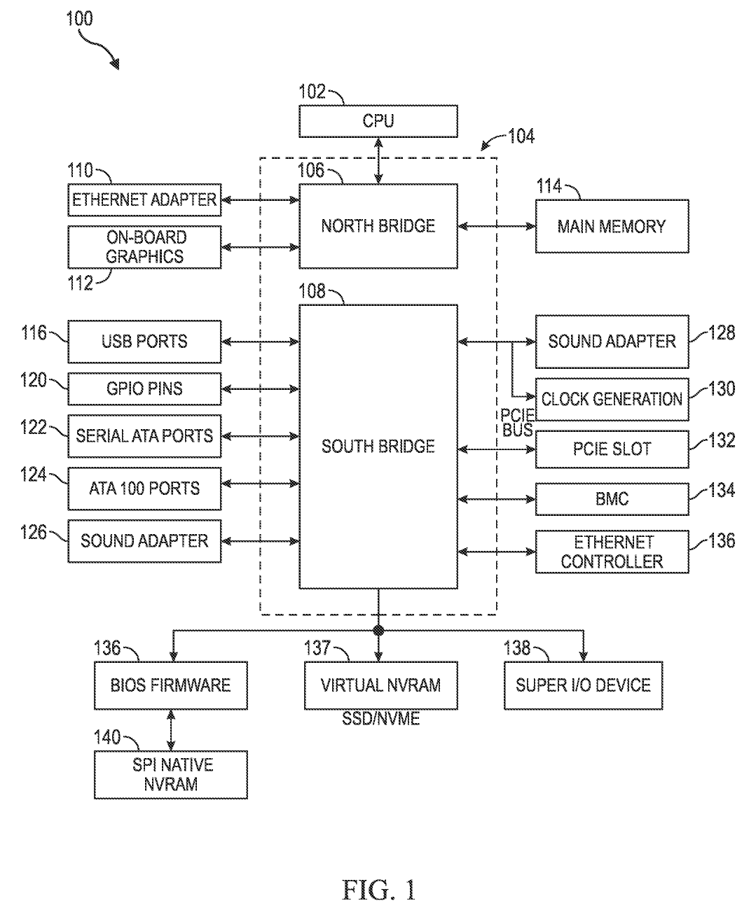

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Host TPM Attestation, whether Identity (e.g., EK, IDevID, or other crypto identifier) or Integrity-based (e.g., PCR) has conventionally required a Host OS software agent to perform attestation against the TPM. With an OS Agent, certain PCRs (e.g., “Below the OS” PCRs) may be unable to be attested in certain scenarios without booting the OS, particularly in scenarios, such as no OS is installed, or when the OS or OS agent continually crashes. With an OS Agent, if the OS is maliciously compromised (e.g., UEFI Secure Boot, Trusted Launch, etc.), the Host TPM attestation can be compromised (e.g., replaying previous nonces, etc.), such as creating a circular dependency. In a typical enterprise product, both out-of-band and in-band domains need to be attested to provide comprehensive system/node level view. Host only attestation is often not sufficient. Additionally, PCR brittleness should be avoided, where unintended/unintentional changes in PCRs cause system misbehaviors. (i.e. Key sealing, etc.). As will be described in detail herein below, embodiments of the present disclosure provide an OS agnostic attestation of an IHS system and method that performs in-band as well as out-of-band attestation of firmware using a TPM proxy.

FIG. 1 shows an example of an IHS 100 that may be configured to implement an OS agnostic attestation of an IHS system and method according to one embodiment of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 128, Ethernet controller 136, and one or more general purpose input/output (GPIO) pins 120. Southbridge 108 may also provide a bus for interfacing peripheral card devices such as PCIe slot 132. In some embodiments, the bus may include a peripheral component interconnect (PCI) bus. Southbridge 108 may also provide baseboard management controller (BMC) 134 for use in managing the various components of the IHS 100. Clock generation circuitry 130 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 122 and/or an ATA100 adapter for providing one or more ATA100 ports 124. Serial ATA ports 122 and ATA100 ports 124 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 132, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 134 may include non-volatile memory having program instructions stored thereon that enable remote management of the IHS 100. For example, BMC 134 may enable a user to discover, configure, and manage the IHS 100, setup configuration options, resolve and administer hardware or software problems, etc. Additionally or alternatively, BMC 134 may include one or more firmware volumes, each volume having one or more firmware files used by the BIOS’ firmware interface to initialize and test components of the IHS 100.

As a non-limiting example of BMC 134, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

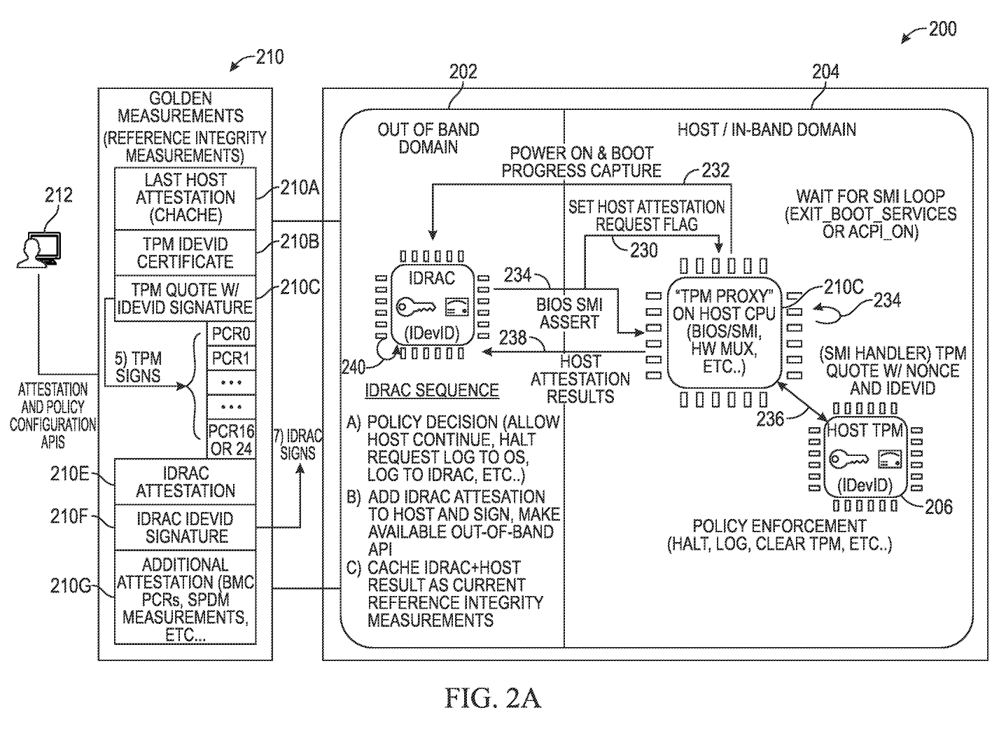

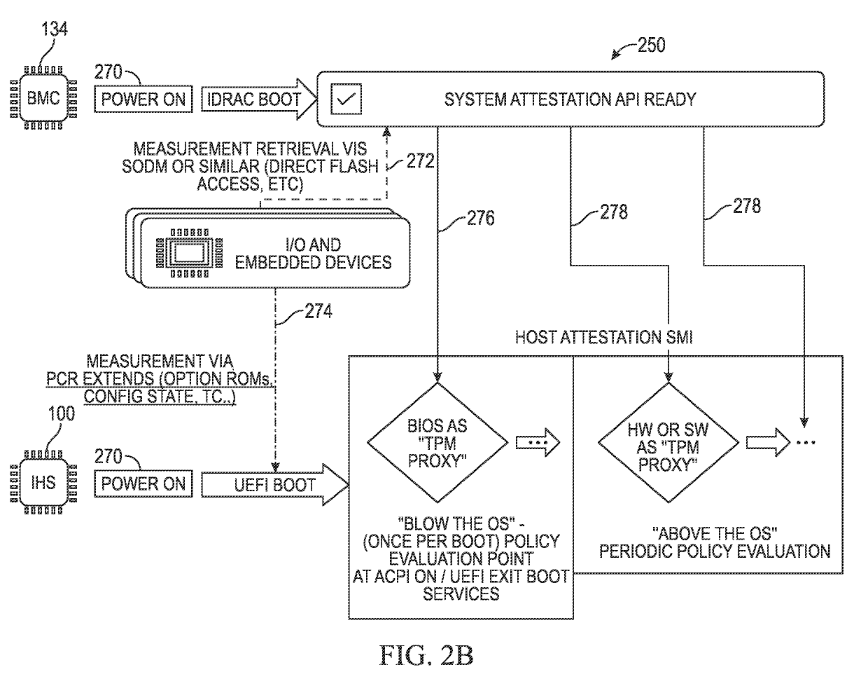

FIG. 2A illustrates an example OS agnostic attestation of an IHS system 200 showing how firmware, as well as hardware, may be attested without the necessity of an OS host agent according to one embodiment of the present disclosure. The OS agnostic attestation of an IHS system 200 generally includes an IHS 100 that is configured with an out-of-band domain 202 and an in-band domain 204. In this particular embodiment, the out-of-band domain 202 may encompass that of a BMC 134, while the in-band domain 204 may encompass that of an OS associated with the his 100.

The IHS 100 is configured with a TPM 206 that performs attestation with the BMC 134 to generate golden measurements 210a-g (collectively 210) that may be used to verify the integrity of the firmware, as well as the hardware configured on the IHS 100. In one embodiment, the OS agnostic attestation of an IHS system 200 includes a TPM proxy 208 to arbitrate access to the TPM 206 by the BMC 134, while allowing the BMC 134 to function as a coordinator for generating and attesting the IHS 100 against the measurements 210. The measurements 210 may include, for example, a last host attestation cache 210a, a TPM initial device identity (IdevID) certificate 210b, a TPM quote with IDevID signature 210c, one or more PCR measurements 210d that may be associated with the in-band domain 204.

The measurements 210 may also include measurements associated with the out-of-band domain 202 (e.g., BMC 134) including a BMC attestation 210e, a BMC IDevID signature 210f, and various additional attestation measurements 210g. While the following measurements 210 are shown and described, it should be appreciated that in other embodiments, additional, different, or fewer measurements 210 may be used without departing from spirit and scope of the present disclosure. Additionally in one embodiment, the OS agnostic attestation of an IHS system 200 may include an attestation and policy configuration API 212 to allow a user to select which measurements 210 are to be used with the OS agnostic attestation of an IHS system 200.

The BMC 134 commences an attestation cycle by initially setting a host attestation request flag with the TPM proxy 208 at step 230. The TPM proxy 208 responds by powering on and setting a boot capture progress flag at step 232. At step 234, the TPM proxy 208 includes logic to wait for a system management interrupt (SMI), which is then initiated by the BMC 134. At this point, the TPM proxy 208 arbitrates access to the TPM 206 by the BMC 134 at step 236 in which it receives the measurements at step 238. At step 240, the BMC 134 makes a policy decision based upon the success or failure of the attestation results. For example, the BMC 134 allow the IHS 100 to continue its boot process if the host attestation results are successful, while either halting the boot process or logging the event that failed. As another example, the BMC 134 may sign the attestation results and make them available to the API 212 if the results fail. As yet another example, the BMC 134 may cache the last host cache results 210a for future reference.

Referring now to FIG. 2B, an example timeline 250 illustrating how the example OS agnostic attestation of an IHS system 200 may perform attestation on the components of the IHS 100 according to one embodiment of the present disclosure. Additionally or alternatively, the timeline 250 may be performed by the OS agnostic attestation of an IHS system 200 as shown and described above with reference to FIGS. 2A and 2B.

Initially at step 270, the IHS 100 and BMC 134 are powered on. When the BMC 134 completes its booting process, it may perform measurement retrieval from any I/O and devices 250 configured in the IHS 100 at step 272. The BMC 134 may also obtain PCR measurements when the host IHS 100 is temporarily asserted using SMI at step 274. At step 276, the BMC 134 may use the TPM proxy 208 to obtain and compare measurements before the IHS 100 has completed booting (e.g., “below the OS”). After measurements have been conducted and booting has completed, the BMC 134 may, at an ongoing basis (e.g., periodically) perform measurements (e.g., “above the OS”) using the TPM proxy 208 at step 278. Thus, the integrity of the IHS 100 may be maintained throughout its usage.

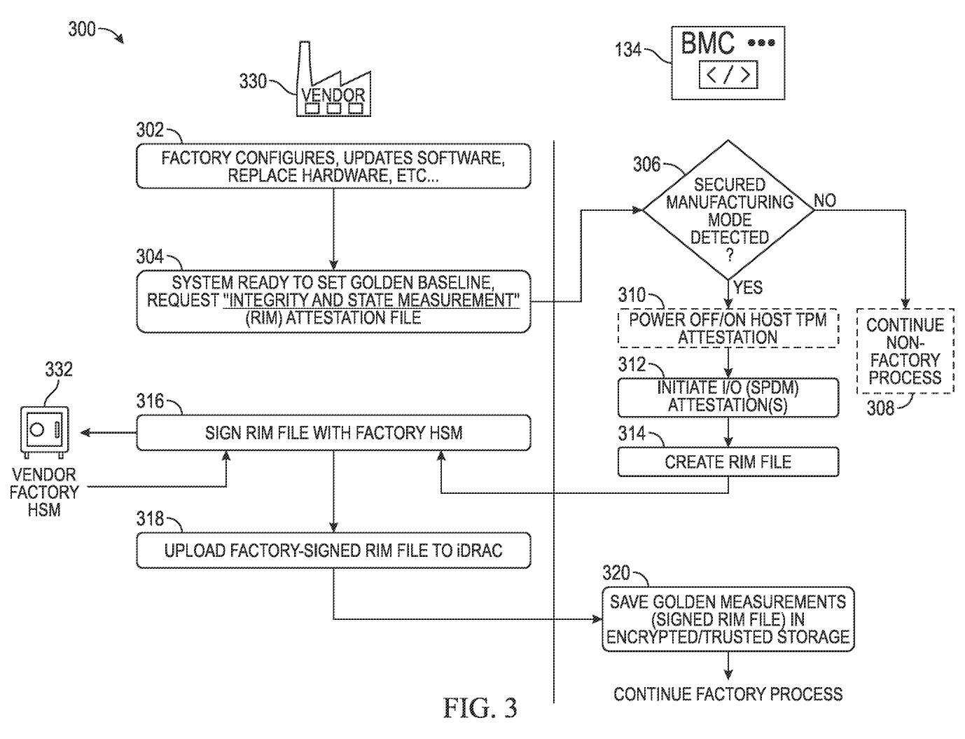

FIG. 3 illustrates an example vendor factory golden baseline generation method 300 that may be performed by a vendor of the IHS 100 according to one embodiment of the present disclosure. For example, the vendor factory golden baseline generation method 300 may be performed by a vendor who manufactures or otherwise assembles the IHS 100 and provides it to a customer.

Initially at step 302, a factory 330 of the vendor configures, updates software, replaces hardware, and the like on the IHS 100. At step 304, the factory 330 issues a request to the BMC 134 for an Reference Integrity Manifest (RIM) attestation file. The RIM attestation file may be, for example, a file that stores measurements, such as the golden measurements 210 described above with reference to FIG. 2A. At step 306, the BMC 134 receives the request, and determines whether a secured manufacturing mode is detected. If not, processing continues at step 308 where assembly of the IHS 100 is completed in a conventional manner. If, however, a secured manufacturing mode is detected, processing continues at step 310 in which the OS agnostic attestation of an IHS system 200 (e.g., host TPM attestation) is powered on.

The SPDM attestations are initiated at step 312, and the RIM file is created at step 314 by the BMC 134. The RIM file is then sent to the factory 330 where it is signed by a factory hardware security module (HSM) 332 at step 316, and uploaded to the BMC 134 at step 318. Thereafter at step 320, the BMC 134 stores the signed RIM file in its own encrypted, secured storage.

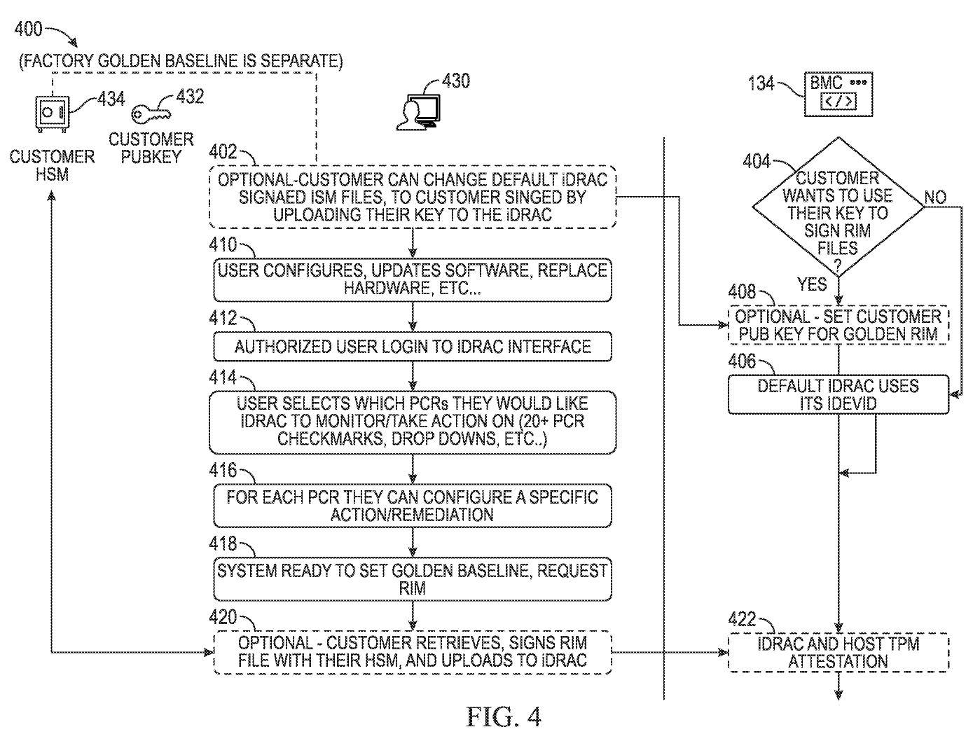

FIG. 4 illustrates an example customer golden baseline generation method 400 that may be performed by a customer 430 of the IHS 100 according to one embodiment of the present disclosure. Whereas FIG. 3 described a method 300 generating a golden baseline file by a vendor of the IHS 100, the present method 400 describes the steps that may be performed by a customer 430 who has obtained the IHS 100 from its vendor.

Initially at step 402, the customer 430 may optionally change the default signed RIM file be customer signed by uploading their customer public key 432 that may have been obtained from their customer HSM 434. The BMC 134 then receives user input for selecting whether the customer 430 uses their public key 432 to sign the RIM file at step 404. If the customer 430 does not want to use their own key 432, then processing continues at step 406 in which the BMC 134 uses its own IdevID; otherwise, processing continues at step 408 where the BMC 134 sets the customer public key 432 for the golden RIM file.

At step 410, the customer 430 configures, updates software, replaces hardware, and the like on the IHS 100. The customer 430 then logs in to the BMC 134 user interface at step 412, and at step 414, selects which PCR’s or other measurements 210 that they would like to have the BMC 134 monitor. At step 416, the BMC 134 then receives user input for assigning a policy (e.g., an action/remediation) for each measurement 210 based upon whether its measurement fails or not. For example, if a measurement fails, the BMC 134 can be instructed to halt boot progression with certain following sub-options, such as a) boot can progress, with a BMC 134 Authorized Access Control Interface (i.e. Admin, Security Officer), b) F1/F2 physical or remote key press to continue boot, c) configurable time delay (i.e. 30 minute delay). Other policies, for example, may include BMC-based alerting and logging, generating a host OS Event Log, and/or performing a forced OS Shutdown (e.g., Hard, Graceful, etc.).

Several scenarios exist where customization of the policies may be useful. For example, if a customer configures a lockdown or system baseline on a storage appliance, if any of the host PCRs (up to PCR16) mismatch then would like to halt, until a Security Officer logs in the iDRAC and authorizes a one-shot continue command. For another example, if a customer has pre-configured the BMC 134 to log and alert only if “Code – Below the OS”(e.g., even) PCRs mismatch, they would like set a policy for the host to continue booting to the OS, with an alert event sent to a control plane (e.g., Maintenance and Orchestration (M&O)) application. For yet another example, if a customer is debugging a malware issue, and wants watch boot progress code during power up, and would like to view the current PCRs during bootup, and during the runtime OS, an appropriate policy can be set to do this. For yet another example, if a customer only wants the system to halt on unexpected UEFI Secure Boot changes (e.g., PCR7 only), and to log on other PCRs (rest of the odd PCRs) mismatch, an appropriate policy for PCR7 may be set to do this.

Referring again to FIG. 4, at step 418, the customer 430 issues a request to the BMC 134 for an Reference Integrity Manifest (RIM) attestation file. Additionally, the customer 430 may optionally sign the RIM file with their private key, and upload the signed RIM file to the BMC 134 at step 420. Thereafter at step 422, the BMC 134 may perform attestation of itself and the host OS at ongoing intervals on the IHS 100.

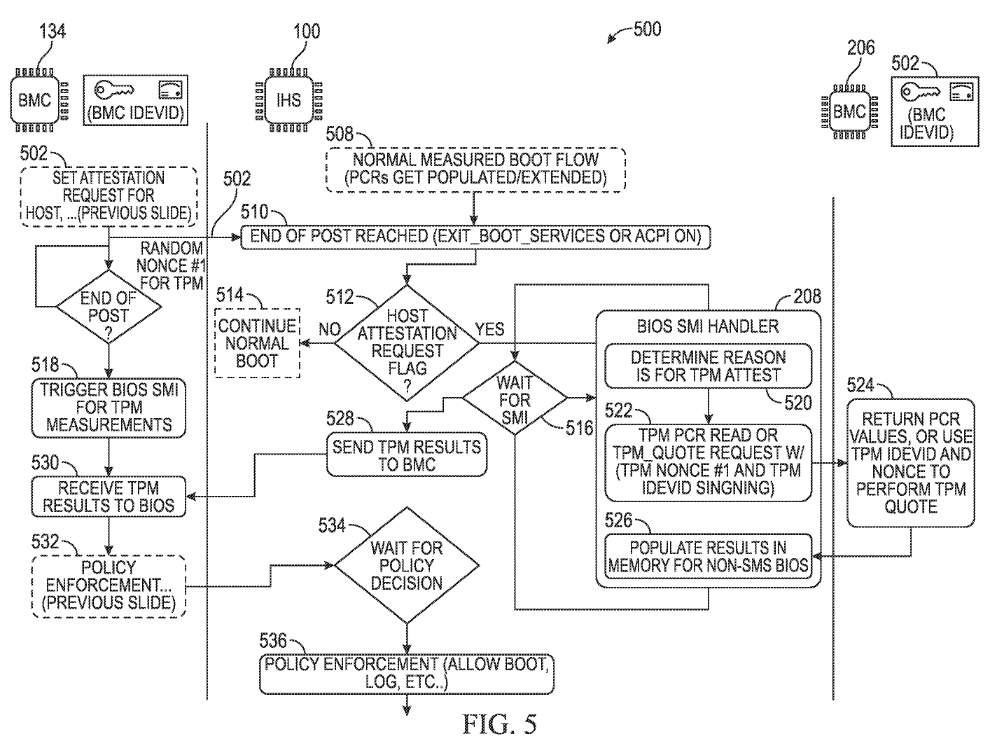

FIG. 5 illustrates an example boot-time attestation method 500 that may be performed to attest the firmware and hardware during a boot process of an IHS 100 according to one embodiment of the present disclosure. Additionally or alternatively, the timeline 250 may be performed by the OS agnostic attestation of an IHS system 200 as shown and described above with reference to FIGS. 2A and 2B. In one embodiment, the boot-time attestation method 500 may be performed each time that the IHS 100 is bootstrapped.

Initially at step 502, the BMC 134 sets an attestation request for the IHS 100. Thereafter at step 504, the BMC 134 generates and sends a first random nonce to the IHS 100, and at step 506, waits for the completion of Power On Self Test (POST) (e.g., completion of BIOS/UEFI boot sequence). The IHS 100 then performs the normal measured boot flow at step 508. For example, the IHS 100 may perform measurements as described above at steps 236 and 238 with reference to FIG. 2A. When the end of POST is reached at step 510, the IHS 100 determines whether the host attestation request flag (e.g., step 504) has been set at step 512. If not, processing continues at step 514 in which normal boot processes are performed; otherwise, processing continues at step 516 in which the IHS 100 waits for completion of SMI.

When the POST has completed, the BMC 134 triggers the BIOS SMI at step 518, which in turn, causes the TPM proxy 208 to determine that it is being called to perform TPM attestation at step 520, and obtain measurements 210 at step 522, which are then sent to the TPM 206. The TPM 206 then signs, using its TPM IDevID 502, the measurements 210 (e.g., PCR values), such as, for example, in response to a TPM quote command at step 524. At step 526, the TPM 206 receives the signed measurements 210 and first random nonce, and populates the results in it secure memory. The TPM 206 then sends the signed measurements 210 and first random nonce to the BMC 134 at step 528.

When the BMC 134 receives the signed measurements 210 and first random nonce at step 530, it determines whether any of the measurements have failed. If any have failed (e.g., a mis-match is detected), the BMC 134 may identify any policy enforcements to be applied at step 532. When the IHS 100 receives the policy decisions at step 534, it may enforce those policy decisions at step 536.

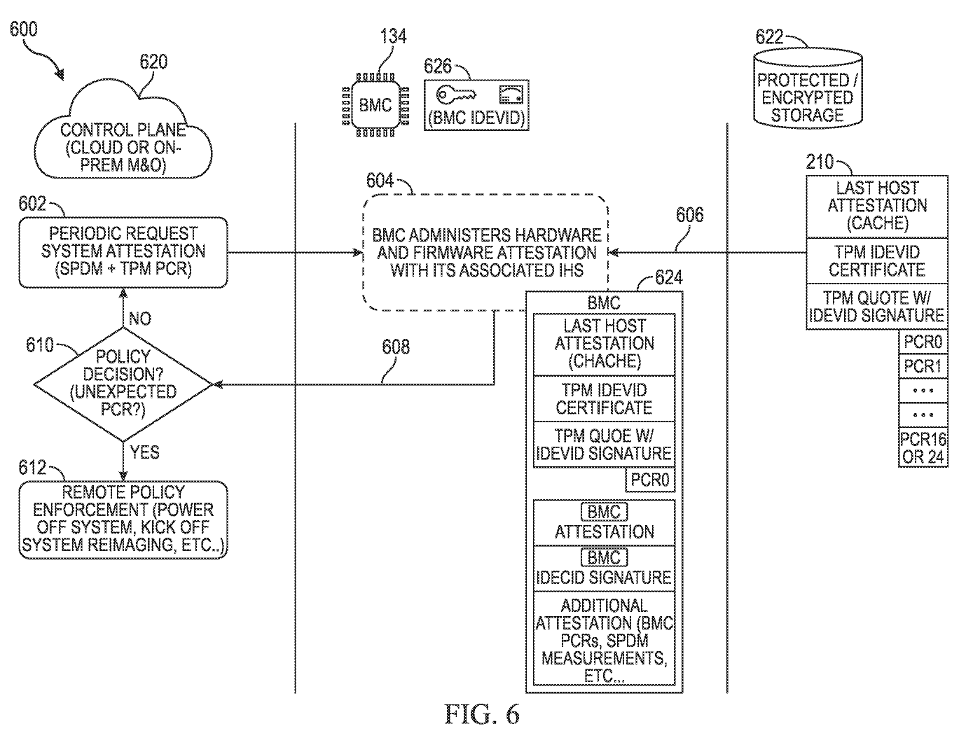

FIG. 6 illustrates an example OS agnostic remote attestation method 600 that may be performed to attest the firmware and hardware of an IHS 100 according to one embodiment of the present disclosure. The OS agnostic remote attestation method 600 may be performed at any time. For example, the OS agnostic remote attestation method 600 may be performed when the IHS 100 is booted, or at any time at ongoing intervals (e.g., periodically) as the IHS 100 is operating. Additionally or alternatively, the timeline 250 may be performed by the OS agnostic attestation of an IHS system 200 as shown and described above with reference to FIGS. 2A and 2B. The OS agnostic remote attestation method 600 may be particularly useful for providing common policy enforcement on multiple IHSs 100, such as with multiple servers configured in a data center, or with multiple computing devices used in an enterprise, such as a factory, a business, or an organization.

At step 602, a remote control plane 620 issues a request to a BMC 134 to perform attestation. The control plane 620 may be any type, such as a systems manager that is configured to manage the operation of multiple IHSs100. Additionally, the control plane 620 may communicate with the BMC 134 through a cloud (e.g., the Internet), or via an on-premises management and orchestration (M&O) tool.

At step 604, the BMC 134 administers hardware and firmware attestation with its associated IHS 100. The hardware and firmware attestation may be at least somewhat similar to the steps performed in FIG. 5 except that in the present OS agnostic remote attestation method 600, policy decisions and enforcement are performed by the control plane 620 as will described herein below. For example, at step 606, the BMC 134 receives the golden measurements 210 from a protected storage portion of the IHS 100, generates current measurements 624, and compares them against each other to determine if any mis-matches have occurred. That is, the BMC 134 may retrieve the last host attestation 210 from protected storage 622, add IDRAC attestation, and sign with its IdevID 626 or Customer Key.

Thereafter at step 608, the BMC 134 sends the attestation results to the control plane 620, which determines whether any measurements 210 are at an unexpected value (value mis-match) at step 610. If not, processing continues at 602 in which the control plane 620 either sends an attestation request to another IHS 100, or waits to send another request to the same IHS 100. If, however, an unexpected value is found, the control plane 620 may perform policy enforcement on that IHS 100 at step 612. For example, the control plane 620 may power off the IHS 100, quarantine the IHS 100, log the unexpected value, or commence re-imaging of the firmware in the IHS 100.

The steps of the OS agnostic remote attestation method 600 may be performed for each of multiple IHSs 100 that the control plane is adapted to manage. Nevertheless, when use of the method 600 is no longer needed or desired, the process ends.

Although FIGS. 2A-B through 6 describe how the OS agnostic attestation of an IHS system may be used for attesting the integrity of the hardware and firmware of one or more IHSs 100, the features of the process may be embodied in other specific forms without deviating from the spirit and scope of the present disclosure. For example, either of the methods may perform additional, fewer, or different operations than those described in the present examples. For another example, either of the methods may be performed in a sequence of steps different from that described above. For yet another example, either of the methods may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a Baseboard Management Controller (BMC) comprising a memory coupled to a processor, the memory having program instructions that, upon execution by the processor, cause the BMC to:
perform one or more current attestation measurements on software configured in the IHS using a Trusted Platform Module (TPM) proxy;
obtain golden measurements associated with the software;
determine whether any of the attestation measurements are unexpected; and
perform one or more remediation policies based on the determination.

2. The IHS of claim 1, wherein the program instructions, upon execution by the host processor, further cause the BMC to send the determination of the attestation measurements to a control plane, wherein the control plane is configured to perform the one or more remediation policies based on the determination.

3. The IHS of claim 1, wherein the program instructions, upon execution by the host processor, further cause the BMC to execute a System Management Interrupt (SMI) to access the TPM proxy, wherein the TPM proxy arbitrates access to the TPM by the BMC.

4. The IHS of claim 3, wherein the TPM is configured to use its initial device identity (IDevID) to sign the current attestation measurements.

5. The IHS of claim 1, wherein the program instructions, upon execution by the host processor, further cause the BMC to perform the acts of performing one or more attestation measurements, communicating with the TPM proxy, and determining whether any of the attestation measurements are unexpected while the IHS is being booted.

6. The IHS of claim 1, wherein the program instructions, upon execution by the host processor, further cause the BMC to perform the acts of performing one or more attestation measurements, communicating with the TPM proxy, and determining whether any of the attestation measurements are unexpected during run time of the IHS.

7. The IHS of claim 1, wherein the golden measurements are signed by a Hardware Security Module (HSM) of a vendor of the IHS prior to being stored in a secure memory of the BMC.

8. The IHS of claim 1, wherein the golden measurements are signed by a user of the IHS prior to being stored in a secure memory of the BMC.

9. The IHS of claim 1, wherein the software comprises at least one of a Platform Configuration Register (PCR), the Operating System (OS) of the IHS, and a firmware of a hardware component configured in the IHS.

10. An Operating System (OS) agnostic attestation method comprising:
performing, using a Baseboard Management Controller (BMC), one or more current attestation measurements on software configured in an Information Handling System (IHS) using a Trusted Platform Module (TPM) proxy;
obtaining, using the BMC, golden measurements associated with the software;
determining, using the BMC, whether any of the attestation measurements are unexpected; and
performing, using the BMC, one or more remediation policies based on the determination.

11. The OS agnostic attestation method of claim 10, further comprising sending the determination of the attestation measurements to a control plane, wherein the control plane is configured to perform the one or more remediation policies based on the determination.

12. The OS agnostic attestation method of claim 10, further comprising executing a System Management Interrupt (SMI) to access the TPM proxy, wherein the TPM proxy arbitrates access to the TPM by the BMC.

13. The OS agnostic attestation method of claim 10, further comprising performing the acts of performing one or more attestation measurements, communicating with the TPM proxy, and determining whether any of the attestation measurements are unexpected while the IHS is being booted.

14. The OS agnostic attestation method of claim 10, further comprising performing the acts of performing one or more attestation measurements, communicating with the TPM proxy, and determining whether any of the attestation measurements are unexpected during run time of the IHS.

15. A non-transitory memory storage device having program instructions stored thereon that, upon execution by a Baseboard Management Controller (BMC), cause the BMC to:
perform, using a Baseboard Management Controller (BMC), one or more current attestation measurements on software configured in an Information Handling System (IHS) using a Trusted Platform Module (TPM) proxy;
obtain, using the BMC, golden measurements associated with the software;
determine, using the BMC, whether any of the attestation measurements are unexpected; and
perform, using the BMC, one or more remediation policies based on the determination.

16. The non-transitory memory storage device of claim 15, wherein the program instructions, upon execution by the host processor, further cause the BMC to send the determination of the attestation measurements to a control plane, wherein the control plane is configured to perform the one or more remediation policies based on the determination.

17. The non-transitory memory storage device of claim 15, wherein the program instructions, upon execution by the host processor, further cause the BMC to execute a System Management Interrupt (SMI) to access the TPM proxy, wherein the TPM proxy arbitrates access to the TPM by the BMC.

18. The non-transitory memory storage device of claim 15, wherein the program instructions, upon execution by the host processor, further cause the BMC to perform the acts of performing one or more attestation measurements, communicating with the TPM proxy, and determining whether any of the attestation measurements are unexpected while the IHS is being booted.

19. The non-transitory memory storage device of claim 15, wherein the program instructions, upon execution by the host processor, further cause the BMC to perform the acts of performing one or more attestation measurements, communicating with the TPM proxy, and determining whether any of the attestation measurements are unexpected during run time of the IHS.

20. The non-transitory memory storage device of claim 15, wherein the golden measurements are signed by a Hardware Security Module (HSM) of a vendor of the IHS prior to being stored in a secure memory of the BMC.
